(19) United States
(12) Patent Application Publication
(10) Pub. No.: US 2003/0159294 A1
(43) Pub. Date: Aug. 28, 2003

(54) Laser-assisted joining device

(76) Inventor: Clive G. Whittenbury, Yuba City, CA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(21) Appl. No.: 10/388,887

(22) Filed: Mar. 15, 2003

Related U.S. Application Data
(63) Continuation-in-part of application No. 10/127,917, filed on Apr. 22, 2002, now abandoned.
Application No. 10/127,917 is a division of application No. 09/545,663, filed on Apr. 7, 2000, now Pat. No. 6,476,347.
Application No. 09/545,663 is a continuation of application No. 09/009,908, filed on Jan. 21, 1998, now abandoned.

(51) Int. Cl. B26B 3/06

(52) U.S. Cl. 30/155

(57) ABSTRACT

The present invention provides an apparatus and method for joining together the surfaces of wood or similar material by introducing laser light between the surfaces just before the surfaces are forced together. A preferred embodiment of the joining apparatus is a generally broad wedge-shaped blade having planar lower and upper surfaces, which converge toward each other to terminate along an intersecting edge. The blade is generally hollow with a cavity for passing optical fibers carrying laser light to a transparent window attached to the intersecting edge of the blade. Laser light passes through the window and is directed into the closed cavity that is bounded by the windowed intersecting edge of the wedge and the two surfaces of the material, which surfaces converge to the closed end of the cavity where the material is joining together. A pressure roller directly applies force at the line of initial contact between the two surfaces to ensure close contact between the closing surfaces at the same time that the closing surfaces are illuminated by the laser light.

### CROSS REFERENCE TO RELATED APPLICATIONS

This is a continuation-in-part application of application Ser. No. 10/127,917 filed Apr. 22, 2002, which is a divisional of application Ser. No. 09/545,663 filed Apr. 7, 2000, which is a continuation of application Ser. No. 09/009,908 filed Jan. 21, 1998. This application is related to application Ser. No. 09/545,444 filed Apr. 7, 2000, U.S. Pat. No. 6,294,757; and application Ser. No. 09/545,663 filed Apr. 7, 2000, U.S. Pat. No. 6,476,347.

### BACKGROUND OF THE INVENTION

The present invention relates generally to joining devices and more specifically to a method and device for joining wood, and other materials capable of being joined by similar techniques, with the assistance of a laser.

Many devices for joining wood and similar materials are known in the art. These devices generally use glue or cements to join two pieces of material. The glue or cements are generally in liquid form and flow into the irregularities of each surface, to ensure complete contact, and both heat and pressure are applied to facilitate the bonding of the material at the surfaces. In growing bio-systems, such as trees, molecular forces build up the wood molecule-by-molecule directly at the molecular level during growth without the need for pressure or heat. Some animals, including the gecko, provide examples of molecular forces being used directly to join surfaces without heat or pressure: the gecko exploits Van der Waals forces (electron attractive forces at the molecular level) to attach one surface to another by using fine fibriles (setae) on their feet to attach to the surface. The resulting forces are sufficiently strong to support many times the weight of the gecko as it climbs walls and hangs from the ceiling. The scientific basis for this is described in the scientific journal Nature, Vol. 405, Jun. 8, 2000, pp.681-684, which states that although manufacturing small, closely packed arrays mimicking setae may presently be beyond the limits of human technology, the natural technology of gecko foot-hairs provides the biological inspiration for future design of “a remarkably effective adhesive.”

The present invention is based upon assisting, through a mechanical device incorporating a laser, the direct molecular bonding of materials in general and more specifically to the joining of two wood surfaces without the need for glue or other foreign materials.

The prior art for joining materials that can be melted, such as metals, includes welding and brazing. These materials are melted in the immediate vicinity of where they are to be joined and the material is allowed to flow together and rapidly solidify to complete the joining of the two materials. This art does not apply to wood and other polymeric materials because they cannot be melted and therefore cannot flow together. Heating wood in an attempt to change its solid phase destroys its molecular structure and integrity. Welding metals, however, does exploit molecular bonding at the molecular level because the atoms are free to move in the melt and then, on cooling, bond together again to form similar material through subsequent solidification and crystallization. The present invention exploits molecular bonding between wood surfaces by energizing the molecular bonds directly with light rather than heat. The scientific process of changing molecular bond energy levels with light photons is known generally as photo dissociation, because many practical applications are for breaking molecular bonds through photochemical reactions to create other substances without the need for heat.

The primary difference between photochemical reactions and chemical reactions through heating processes is that photochemistry energizes the electrons while heating energizes the whole molecule. When a laser is used to provide the photochemical light energy with the exact amount of energy, no more no less, the energy required for the photochemistry process is minimal. The difference in energy efficiency between the photochemical and thermo-chemical processes can, in principle, therefore be very large. Practical and economic manufacturing consequences are, therefore, expected to be very large and significant in favor of photochemistry over thermally energized chemistry.

Photochemistry and photodissociation enjoy an extensive international foundation in scientific and industrial research. Leading universities and science institutes have published extensively in these fields and the principles, as they might apply to the science underlying the present invention, are available throughout the literature. A dated but articulate publication by the National Academy of Sciences overviews these fields and provides insight into their industrial applications (Atomic, Molecular, and Optical Science: An Investment in the Future: Committee on Atomic, Molecular, and Optical Sciences, National Research Council, National Academies Press, 1994). An academic and thorough review of molecular bonding that refers to selective energizing of molecular bonds (as would be applied in the present invention) is to be found in Bond-Selected Chemistry: Vibrational State Control of Photodissociation and Bimolecular Reaction in the Journal of Physical Chemistry, 1996 Vol. 100, pp 12725-12734. The author is F. Fleming Crim of the Department of Chemistry at The University of Wisconsin, Madison, Wis. An experimental review of intermolecular forces is to be found in Intermolecular Interactions by Martina Havenith, Springer-Verlag Berlin, 2002.

The energizing of molecular bonds by light is a reversible process: when the light is removed the electron gives up the extra energy that it received from the light and the strength of the bond is regained (highest strength being when the electron is at its lowest energy in the molecule). If the electrons are energized to the point where the molecular bond is very weak, this process assists the separation or cutting of materials when mechanical force is applied to break the molecular bonds apart. However, if the electrons are energized by light shining at already separated surfaces that are being pushed together, then the energized electrons can bond together the molecules that face each other from across the closing gap between the surfaces. As the gap closes, the light is reduced and the electrons fall back into their lower energy states thereby allowing the molecules to bond together in the same way that they already enjoy with their neighbors.

In summary, the same photochemical process can be used, in principle, for either cutting or joining of the materials.

U.S. Pat. No. 6,294,757 and U.S. Pat. No. 6,476,347 describe a device and method similar to the present invention but that use the weakening of molecular bonds by laser light to assist the cutting of materials. A time reversal of the cutting process, using a modified version of the device, would allow the joining of materials by energizing those molecular bonds that enable cohesion between material surfaces at nano-scale. Such cohesion would obviate the necessity for glues and other foreign materials normally required for joining materials together.

The commercial introduction of a method for joining wood and other polymer materials together by direct use of the natural molecular properties in the material itself would eliminate the costs and environmental problems associated with glues and other artificial adhesives. The resulting efficiencies, as well as environmental and productivity improvements in manufacture could be substantial.

### SUMMARY OF THE INVENTION

The present invention provides a method and apparatus for joining wood, or other materials capable of being joined using similar methods, by pressing the materials together along a controlled line of contact through the application of mechanical force, wherein control of the line is imparted by a wedge (e.g., knife blade) in combination with a pressure roller fixed in position with respect to the wedge while, simultaneously, using a laser beam at the line of controlled contact to energize those molecular bonds that naturally hold these materials together.

Advantages of the present invention include efficient joining without the need for foreign substances such as environmentally undesirable glues, and the elimination of expensive or time-consuming glue preparation techniques.

The present invention uses laser light to assist a mechanical joining device that includes a blade and mechanical pressure generating mechanism, by locally energizing molecular bonds at the two surfaces of the material along a line of controlled contact. The laser light energizes molecular bonds at the line of controlled contact between the materials being joined while the blade guides the material as it withdraws from between the joining surfaces and away from the line of controlled contact behind the blade. The laser will allow the use of low mechanical forces and can reduce or eliminate the need for heating glues and the materials themselves in the process of joining the materials together.

In a preferred embodiment of the invention, the intersecting edge of a wedge-shape mechanical blade contains a window made of a material that transmits laser light. Light from a laser reaches the window through optical fibers connected to, and contained in the body of, the blade. During a joining operation laser light from the laser unit is directed through a window mounted at the intersecting edge of the blade, and into the region beyond the blade where a line of controlled contact is illuminated by the laser light. The laser light energizes the molecular bonds at the contacting surfaces of the wood to assist the joining process at the line of contact.

The laser overcomes the natural repulsive forces, which define material surface boundaries from each other, by energizing the related electrons into admitting attractive forces and subsequent molecular bonding between the two surfaces. The mechanical force required to join the materials together is, therefore, directly assisted by the laser energy and significantly reduces or eliminates the need for high force, heating and strong mechanical equipment (in combination with glue) for the conventional joining of the surfaces. The present invention is therefore expected to increase manufacturing productivity over conventional gluing devices representing the prior art.

A further understanding of the nature and advantages of the invention may be realized by reference to the remaining portions of the specification and the drawings.

### BRIEF DESCRIPTION OF THE DRAWINGS

FIG. 1 is a perspective view of the joining device.

FIG. 2 is aside view of the joining device in use.

FIG. 3 is a perspective view of the blade portion of the joining device in use.

### DESCRIPTION OF THE SPECIFIC EMBODIMENTS

The present invention is directed toward improving wood-joining techniques beyond the use of conventional glues and their application in conjunction with high temperatures and pressures. These conventional methods require separate manufacturing steps that are costly, that damage the inherent qualities of the wood and that introduce environmental problems that are difficult to mitigate. Any joining technique that could use the virgin unprocessed materials would avoid these problems and eliminate additional steps in wood products manufacture. In prior art, the joining of metals by welding provides an example of such efficiency, wherein the metal surfaces are melted (but retain their virgin chemical composition) and then re-crystallize to create a joining bridge formed from the original metal. Wood cannot be welded in the same way because it thermo-chemically decomposes rather than melting and then reforming with the original materials. However, the present invention offers a new way of combining the rapidly advancing knowledge of molecular bonding technology with new mechanical equipment to provide a new technique for joining similar materials like wood through a process that has similar advantages to welding processes.

The present invention can use light energy to energize the molecular bonds that bind wood polymer molecules together at the instant that these molecules come together at two joining surfaces. The utility of light energy is transient and therefore must be applied simultaneously with the pressing together of the two joining surfaces. To join two surfaces with any finite area together the present invention creates the join along a line that moves over the joining surfaces. On one side of the line of controlled contact the surfaces are joined permanently and on the other side of the line the surfaces are yet to come together. The present invention achieves this by using a knife wedge whose tip lies along and immediately adjacent to the line of controlled contact. A mechanical pressure generating mechanism such as a roller pushes the material surfaces together just next to and along the tip of the knife wedge while light is introduced through a window in the tip of the knife wedge directly into the line of controlled contact. The present invention therefore achieves the simultaneous application of light and mechanical pressure to facilitate molecular bonding immediately after the light is shut off by the closing contact and the molecular bonds relax to their lower energy states and, thereby, bind the material surfaces together naturally. The use of the knife wedge in the present invention requires the gradual withdrawal of the knife wedge away from, and in a perpendicular direction from, the line of contact. The knife wedge guides the wood into the line of contact while providing the means for applying light to the line of contact. This wedge provides a time reversal of the function of the knife wedge used in the laser-assisted cutting of wood and polymers described in U.S. Pat. No. 6,294,757 and U.S. Pat. No. 6,476,347.

The embodiments of the present invention achieve the practical needs described above through the apparatus described in the accompanying figures.

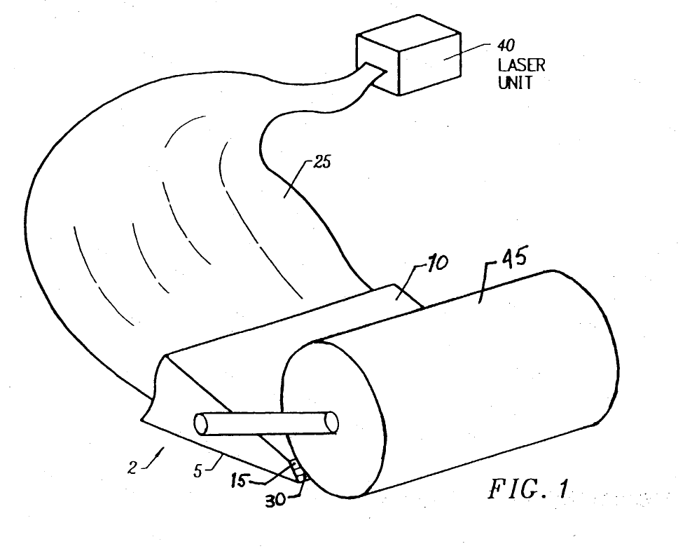

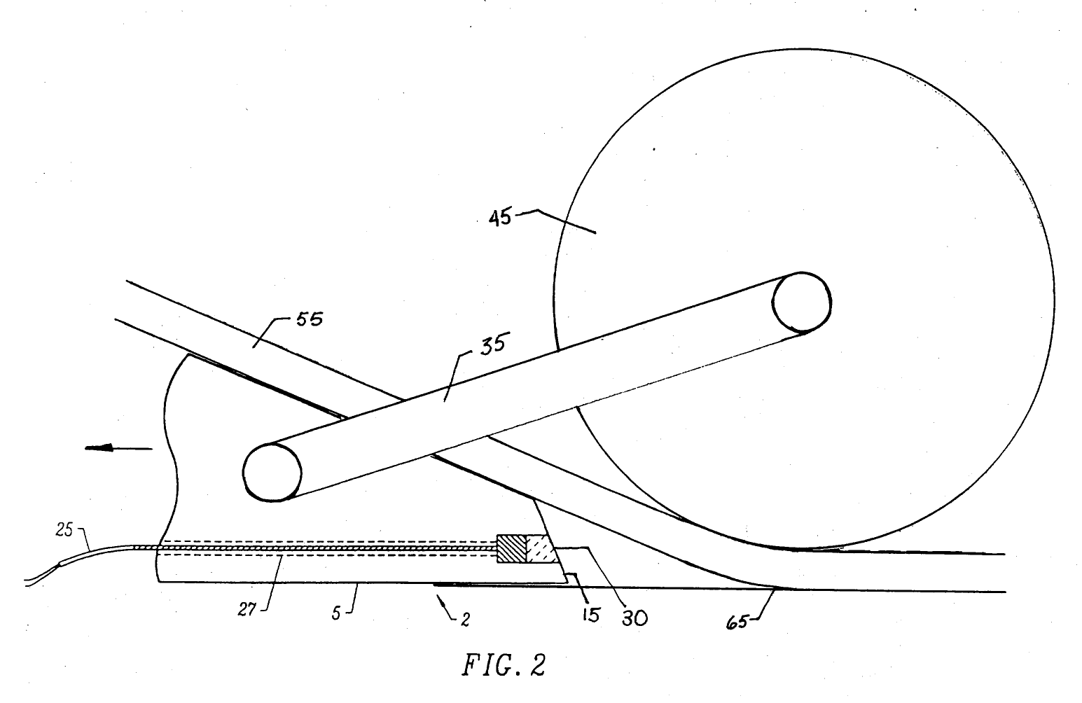

Referring now to FIG. 1 there is shown a preferred embodiment of the invention in the form of a joining knife wedge 2 which may be fabricated of metal or other suitable materials. Wedge 2 is generally wedge-shaped with broad, planar lower and upper surfaces 5, 10 that converge toward each other to terminate along an intersecting edge 15. A preferred embodiment of wedge 2 can be constructed from two pieces, enclosing a cavity 27 (FIG. 2) and firmly attached together such that lower surface 5 and upper surface 10 are smooth and unobstructed. An acute angle formed by lower surface 5 and upper surface 10 may be small or large depending on the joining application.

As shown in FIG. 2, optical fibers 25 pass through the cavity 27 formed by the two parts of the wedge 2 to carry laser light to the intersecting edge 15 of the wedge. The cavity 27 terminates at window 30 along intersecting edge 15. A window 30 extends along intersecting edge 15 of wedge 2 and provides a transparent medium for transmission of laser light from optical fibers 25 into the open region in front of wedge 2.

The window 30 is configured to fit between the lower and upper surfaces 5, 10 at the intersecting edge 15 and fabricated to match optical requirements for propagation of laser light from the optical fibers 25 to the region in front of wedge 2. Window 30 can be made of quartz, glass, diamond or other transparent materials that match the laser characteristics, the expected working environment and the detailed mechanical design of the wedge.

The optical fibers 25 connect a source of laser light illumination, shown here as a laser unit 40, to intersecting edge 15 of wedge 2 for transmission through the window 30.

Several different types of lasers may be used, depending upon the various materials to be joined. Differences in the energy bonds and their characteristics will require different lasers that generate and amplify light of different wavelengths, from ultraviolet to infrared, with different pulse characteristics.

Generally, the present invention operates by projecting laser light produced by laser unit 40 through the optical fibers 25 to the intersecting edge 15 of wedge 2 and through window 30 onto a controlled line of contact 65 between the materials being joined to thereby energize the molecular bonds that naturally hold the bulk material together. The laser light energizes the molecular bonds along the controlled line of contact between the material surfaces, while wedge 2 is retreating from the line of contact between the material surfaces. A mechanical pressure mechanism such as a pressure roller 45 forces the material surfaces together along the line of contact to both seal off the light after it has energized the molecular bonds and hold the surfaces closely together while the molecular bonds relax into their normal (and strongly binding) low energy states. The radius of the pressure mechanism such as roller 45 may match the radius of curvature of the wood surface that is under pressure. The pressure mechanism position may be adjusted so as to avoid applying too much pressure on the wood 55 or similar material that is in immediate contact with the wedge surface.

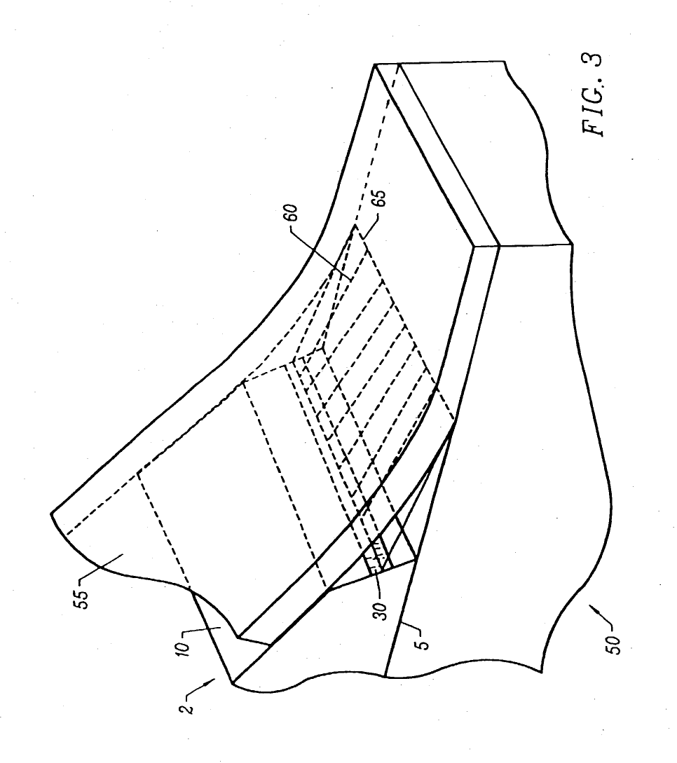

As an example, and referring to FIG. 3, blade 2 is moved along the top of an object 50 with a wood surface while a wood slice 55 feeds along its top surface toward the contact line 65 where the slice meets the wood surface of object 50 at the controlled line of contact 65. A small force is applied to wedge 2 to steady it and withdraw it gradually away from the controlled line of contact. Object 50 and slice 55 are kept apart by the lower and upper surfaces 5, 10 as the wedge retreats along the surface of object 50. Lower surface 5 rests against object 50 while upper surface 10 guides the slice 55 toward the controlled line of contact 65 between the inside surfaces of slice 55 and object 50 approaching the controlled line of contact. The force imparted on slice 55 by roller 45 together with the angle imposed by the wedge causes the slice 55 to bend away from object 50 just next to the controlled line of contact 65 where slice 55 joins object 50. This bending allows the light from the window in the wedge to reach into the line of contact just as the contact is being made and forced by the roller 45 or similar pressure generating mechanism.

The pressure generating mechanism may be a roller 45 as shown in FIG. 1 and FIG. 2 or other similar device for applying downward force onto wood slice 55. As blade 2 is moved back from the line of contact 65, the pressure generating mechanism should move simultaneously thereby advancing the line of contact while applying force to that portion of wood slice 55 joined to the wood surface of object 50.

By way of example, the pressure generating mechanism, such as roller 45, may be directly attached to blade 2 as shown in FIG. 2 by linkage 35 or may be connected indirectly through one or more other objects. Linkage 35 may be spring loaded or mechanically controlled to provide the appropriate force onto wood slice 55 and object 50 during the joining process. Linkage 35 may also be of variable length to control such characteristics as the distance from window 30 to the line of contact 65, or the angle at which wood slice 55 intersects the surface of blade 2.

The joining of fibers by gluing them together in conventional joining techniques requires significant time to process and cure (minutes). In the present invention, the action of light in energizing the molecular bonds is essentially instantaneous with the application of the light. The movement of line of contact 65 (the joining speed) between the surfaces in the case of the present invention is therefore not limited by the inherent characteristics of the joining process. The joining speed limit would be set only by the power of the laser, or its ability to keep up the supply of light energy for the joining process.

Laser light 60 is guided from the laser unit 40 to intersecting edge 15 of blade 2 by optical fibers 25. The optical fibers can be made from flexible fibers, or can be replaced by a waveguide, which can be made from carefully shaped cavities or other standard optical elements for transporting laser light. The optical fibers can be aligned into a flat ribbon as shown in FIG. 1 or can be bound into any other suitable shape that fits within cavity 27.

Laser unit 40 may contain a laser oscillator and amplifier system that generates laser light of suitable power, wavelengths and pulse shape for transmission through optical fibers 25 and through window 30 at the intersecting edge 15 of wedge 2.

The laser light 60 is directed onto the wood surface of object 50 along the controlled line of contact 65 where the wood is to be joined by the strength of its native molecular bonds. The laser light energizes molecular bonds of the wood along a controlled line of contact 65 where wood slice 55 and the wood surface of object 50 are to be joined such that a well defined and accurate joining takes place just beyond wedge 2. The open geometry between the intersecting edge of the blade and the controlled line of contact allows the wedge to direct the laser light into and along the controlled line of contact just beyond the wedge 2. The distance between the intersecting edge of the blade and the controlled line of contact remains constant as wedge moves along the un-joined surface of the wood surface of object 50.

The present invention reduces the manufacturing steps and power required to join wood and other materials capable of being joined by similar techniques, reduces the time necessary to join a given area of wood surface, eliminates preparation for joining and increases the accuracy and quality of the join.

While the above is a complete description of the preferred embodiments of the invention, various alternatives, modifications, and equivalents may be used. Therefore, the above description should not be taken as limiting the scope of the invention which is defined by the appended claims.

What is claimed is:

1. A laser-assisted joining device for joining a slice of wood to a wood surface by the simultaneous application of force and laser light at a line of controlled contact between the slice of wood and the wood surface, comprising:
a separating means for separating the slice of wood from the wood surface before they join along the line of controlled contact, the separating means including a wedge-shaped blade having an upper surface and a lower surface which converge toward each other and terminate, before they meet, along a planar leading surface, said planar leading surface intersects and is connected to the upper surface and lower surface of the blade, wherein the blade separates the slice of wood from the wood surface as the wedge is withdrawn from the line of controlled contact in front of the planar leading surface edge as the separating means is withdrawn from between the slice of wood and the wood surface;
a means for energizing the molecular bonds in the slice of wood and the wood surface along the line of controlled contact while the separating means is withdrawn from between the slice of wood and wood surface by simultaneously directing laser light from at least a portion of the planar leading surface onto the line of controlled contact as the separating means is withdrawn away from the line of controlled contact such that the laser light simultaneously energizes the molecular bonds of the wood along the line of controlled contact without burning the wood, while the upper surface and lower surface of the blade apply force to the wood surface and slice of wood, separating the wood surface and the slice of wood at the line of controlled contact and advancing the line;
a pressure means for applying pressure to the slice of wood against the wood surface in front of the blade to join the slice of wood to the wood surface at the line of controlled contact while the laser light is directed on the advancing line of controlled contact;
a laser source for providing the laser light; and
a means for directing the laser light from the planar intersecting surface of the blade forward onto the line of controlled contact.

2. A laser-assisted joining device as described in claim 1 wherein the means for directing the laser light is a window.

3. A laser-assisted joining device as described in claim 2 wherein the window is made of at least one ingredient selected from the group consisting of quartz and glass.

4. A laser-assisted joining device as described in claim 1 further comprising:
a means for transporting the laser light to the planar intersecting surface of the blade; and at least one opening on the planar intersecting surface of the blade.

5. A laser-assisted joining device as described in claim 4 wherein the means for directing the laser light is a window.

6. A laser-assisted joining device as described in claim 5 wherein the window is made of at least one ingredient selected from the group consisting of quartz and glass.

7. A laser-assisted joining device as described in claim 4 wherein the laser light is within a wavelength range of between ultraviolet and infrared, inclusive.

8. A laser-assisted joining device as described in claim 7 wherein the laser source further comprises a laser oscillator and an amplifier.

9. A laser-assisted joining device as described in claim 4 wherein the laser source further comprises a laser oscillator and an amplifier.

10. A laser-assisted joining device as described in claim 1 wherein the laser light is within a wavelength range of between ultraviolet and infrared, inclusive.

11. A laser-assisted joining device as described in claim 10 wherein the laser source further comprises a laser oscillator and an amplifier.

12. A laser-assisted joining device as described in claim 1 wherein the laser source further comprises a laser oscillator and an amplifier.

13. A method for joining a slice of wood to a wood surface along a line of controlled contact between the slice of wood and the wood surface through the application of controlled separation and force in combination with a laser light comprising the steps of:
placing a joining device comprising a wedge-shaped blade having an upper surface and a lower surface between the slice of wood and the wood surface wherein the upper surface and the lower surface converge toward a leading edge on the blade at an acute angle and are connected to the leading edge;
directing laser light from at least a portion of the leading edge of the blade onto the slice of wood and wood surface along a line of controlled contact; and
applying force to join the slice of wood to the wood surface in front of the blade while simultaneously withdrawing the blade away from the line of controlled contact wherein the upper surface exerts force against the slice of wood while the lower surface exerts force against the wood surface thereby withdrawing the blade and the laser light as the pressure joins the slice of wood to the wood surface along the line of controlled contact.

14. A method for joining a slice of wood to a wood surface as described in claim 13 wherein the joining device further comprises:
a laser source for providing the laser light; and
a means for directing the laser light forward of the leading edge of the blade onto the line of controlled contact.

15. A method for joining a slice of wood to a wood surface as described in claim 14 wherein the means for directing the laser light is a window.

16. A method for joining a slice of wood to a wood surface as described in claim 13 wherein the joining device further comprises:
a means for transporting the laser light to the leading edge of the blade; and
at least one opening on the leading edge of the blade.

17. A method for joining a slice of wood to a wood surface as described in claim 16 wherein the joining device further comprises:
a laser source for providing the laser light; and
a means for directing the laser light forward of the leading edge of the blade onto the line of controlled contact.

18. A method for joining a slice of wood to a wood surface as described in claim 17 wherein the means for directing the laser light is a window.

19. A method for joining a slice of wood to a wood surface as described in claim 14 wherein the laser light is within a wavelength range of between ultraviolet and infrared, inclusive.

20. A method for joining a slice of wood to a wood surface as described in claim 14 wherein the laser source further comprises a laser oscillator and an amplifier.
